(19) United States
(12) Patent Application Publication
(10) Pub. No.: US 2015/0346584 A1
(43) Pub. Date: Dec. 3, 2015

(54) ACTUATOR AND CAMERA MODULE INCLUDING THE SAME

(71) Applicant: SAMSUNG ELECTRO-MECHANICS CO., LTD., Suwon-Si (KR)

(72) Inventors: Boum Seock Kim, Suwon-Si (KR); Hui Sun Park, Suwon-Si (KR); Kang Heon Hur, Suwon-Si (KR); Jung Wook Seo, Suwon-Si (KR)

(73) Assignee: SAMSUNG ELECTRO-MECHANICS CO., LTD., Suwon-Si (KR)

(21) Appl. No.: 14/463,413

(22) Filed: Aug. 19, 2014

(30) Foreign Application Priority Data
May 28, 2014 (KR) 10-2014-0064212

(51) Int. Cl. G03B 13/36; H04N 5/225

(52) U.S. Cl. CPC G03B 13/36; H04N 5/2254

(57) ABSTRACT

An actuator may include a piezoelectric member extended to be elongated in an optical axis direction; and a magnetic body disposed on the piezoelectric member so as to decrease contact wear between the piezoelectric member and a lens barrel. According to exemplary embodiments of the present disclosure, driving reliability of the piezoelectric member maybe improved by decreasing contact wear due to the contact between the lens barrel and the piezoelectric member.

### CROSS-REFERENCE TO RELATED APPLICATION

This application claims the benefit of Korean Patent Application No. 10-2014-0064212 filed on May 28, 2014, with the Korean Intellectual Property Office, the disclosure of which is incorporated herein by reference.

### BACKGROUND

The present disclosure relates to an actuator enabling auto-focusing of a camera module, and a camera module including the same.

Camera modules commonly include a component for changing a focal length of an optical system. For example, a camera module may include a piezoelectric actuator having different deformation characteristics depending on an electrical signal. The piezoelectric actuator may directly contact a lens barrel to move the lens barrel in an optical axis direction.

However, since the piezoelectric actuator directly contacts the lens barrel to transfer driving force required for moving the lens barrel to the lens barrel as described above, deformation and abrasion due to friction may easily occur.

### SUMMARY

Some embodiments of the present disclosure may provide an actuator capable of significantly decreasing various problems generated due to friction with a lens barrel, and a camera module including the same.

According to some embodiments of the present disclosure, a camera module may include a magnetic body disposed on a piezoelectric member, such that contact wear between a lens barrel and a piezoelectric member may be significantly decreased.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an exploded perspective view of a camera module according to an exemplary embodiment in the present disclosure;

FIG. 2 is an assembly perspective view of a lens barrel and an actuator illustrated in FIG. 1;

FIG. 3 is a cross-sectional view of the actuator illustrated in FIG. 2;

FIG. 4 is a longitudinal cross-sectional view of the actuator illustrated in FIG. 2;

FIG. 5 is a cross-sectional view of the actuator, taken along the line A-A of FIG. 4;

FIGS. 6 through 10 are cross-sectional views of actuators having different shapes, taken along line A-A;

FIG. 11 is a cross-sectional view of a magnet member for the actuators illustrated in FIGS. 7 through 10;

FIG. 12 is a cross-sectional view illustrating a detailed configuration of part B illustrated in FIG. 4;

FIGS. 13A through 13C are cross-sectional views for describing an operation state of the actuator illustrated in FIG. 4;

FIG. 14 is a longitudinal cross-sectional view of an actuator according to another exemplary embodiment in the present disclosure;

FIG. 15 is a flow chart illustrating a manufacturing method of an actuator according to an exemplary embodiment of the present disclosure; and

FIG. 16 is a flow chart illustrating a manufacturing method of an actuator according to another exemplary embodiment in the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

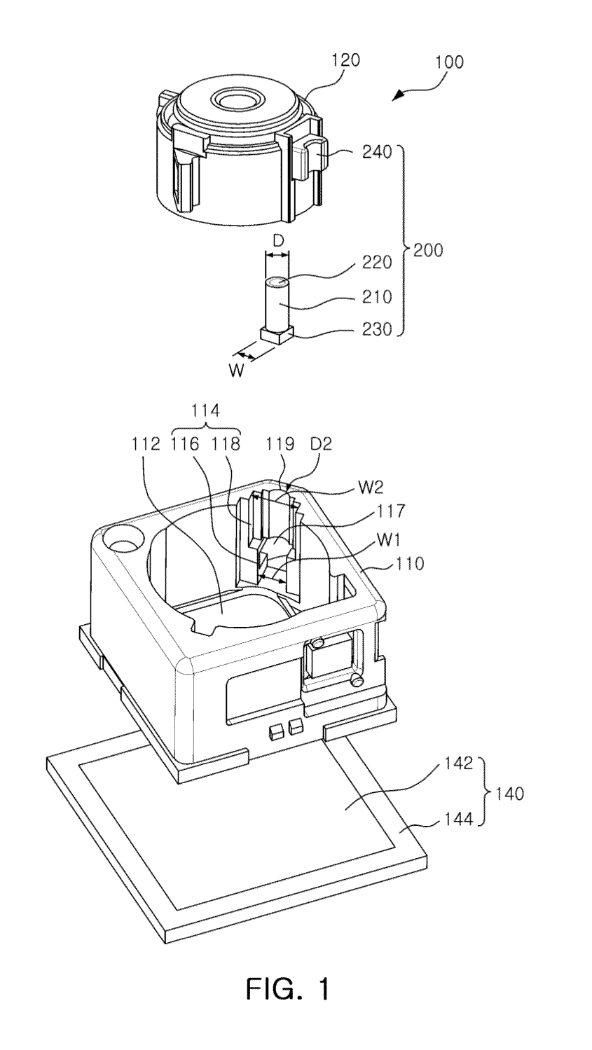

A camera module 100 will hereinafter be described with reference to FIG. 1.

The camera module 100 according to an exemplary embodiment in the present disclosure may include a housing 110, a lens barrel 120, and an actuator 200 as illustrated in FIG. 1. In addition, the lens module 100 may further include an image sensor unit 140. Further, the lens module 100 may further include an additional configuration in addition to the above-mentioned configurations. For example, the lens module 100 may further include a sensor (for example, a hall sensor) sensing a relative position of the lens barrel 120 with respect to the image sensor unit.

The housing 110 may be formed of a material having resistance against external impacts. For example, the housing 110 may be formed of a metal, plastic, or another material having a predetermined degree of rigidity. However, the material of the housing 110 is not limited thereto and may be changed as needed.

The housing 110 may receive the lens barrel 120 and the actuator 200. For example, a receiving part 112 receiving the lens barrel 120 and a mounting part 114 receiving the actuator 200 may be formed in the housing 110.

The receiving part 112 may be generally formed in the center of the housing 110. For example, the receiving part 112 maybe penetrated in a direction perpendicular with respect to one surface of the image sensor unit 140.

A cross section of the receiving part 112 may be larger than that of the lens barrel 120. For example, the receiving part 112 may have a cross section larger than that of the lens barrel 120 so that the lens barrel 120 received in the receiving part 112 may move for active alignment in a vertical direction of an optical axis (hereinafter, referred to as an alignment direction). However, the cross section of the receiving part 112 is not necessarily larger than that of the lens barrel 120, and if necessary, cross sections of the receiving part 112 and the lens barrel 120 may have the same size as each other.

The mounting part 114 maybe formed on an edge adjacent to the receiving part 112. For example, the mounting part 114 may be formed at a corner of the housing 110 as illustrated in FIG. 1. The mounting part 114 is formed at the corner of the housing 110 as described above, which may be advantageous for miniaturizing the lens module 100 due to an increase in space use efficiency of the housing 110.

The mounting part 114 may include a first mounting part 116 and a second mounting part 118.

The first mounting part 116 may receive a piezoelectric member 220 and a mass member 230 of the actuator 200. A width W1 of the first mounting part 116 may be greater than a width W of the piezoelectric member 220. This condition may enable free movement of the piezoelectric member 220 disposed on the first mounting part 116. However, as long as the piezoelectric member 220 may move freely, the width W1 of the first mounting part 116 may be the same as the width W of the piezoelectric member 220. A hole 117 opened toward an outside of the housing 110 may be formed in the first mounting part 116. The hole 117 may be used as a space for leading a flexible substrate connected to the piezoelectric member 220.

The second mounting part 118 may receive a portion of the actuator 200. A width W2 of the second mounting part 118 may be greater than a diameter D of a magnetic body 210. Therefore, the magnetic body 210 received in the second mounting part 118 may not contact a side surface of the second mounting part 118. A groove 119 extended to be elongated in a height direction of the housing 110 may be formed in the second mounting part 118. A cross section of the groove 119 may have an arc shape. A diameter of an arc shape may be D2. However, the shape of the cross section of the groove 119 is not limited to the arc shape but may be changed as needed. The groove 119 may contact the magnetic body 210. For example, the groove 119 may line-contact the magnetic body 210 through at least one line segment extended to be elongated in the height direction of the housing 110. A contact structure of the groove 119 and the magnetic body 210 as described above may be advantageous for arranging the magnetic body 210 so as to be parallel to the height direction of the housing 110.

The lens barrel 120 may include at least one lens. For example, the lens barrel 120 may include at least one lens for projecting light reflected from a subject onto the image sensor unit 140. Optical properties of the lens may be determined according to the kind of lens module 100. For example, the number of lenses included in a high resolution lens module 100 may be four or more, and the number of lenses included in a low resolution lens module 100 may be three or less. Further, the lens barrel 120 may further include a stop adjusting an amount of incident light and a filter cutting off infrared light.

An inner surface of the lens barrel 120 may be coated with an anti-reflective material or a shading material. This configuration may decrease a phenomenon in which unnecessary light is reflected to the inner surface of the lens barrel 120 to thereby be incident on the image sensor unit, such that resolution of the lens module 100 may be improved.

The image sensor unit 140 may include an image sensor 142 and a substrate 144. The image sensor unit 140 may further include at least one electronic component (for example, a passive device) required to drive the image sensor 142. The image sensor 142 may be a charge-coupled device (CCD) type electronic component or a complementary metal oxide semiconductor (CMOS) type electronic component. However, the image sensor 142 is not limited to the above-mentioned type electronic component, but may be changed into another type electronic component as needed. The substrate 144 may include a circuit pattern capable of electrically connecting the image sensor 142 and the passive device. The substrate 144 may further include other electronic components allowing the image sensor 142 to operate smoothly, in addition to the passive device. Meanwhile, the image sensor 142 and the passive device may be formed integrally with the substrate 144. For example, the image sensor 142 and the passive device may be manufactured to have a chip scale package (CSP) form.

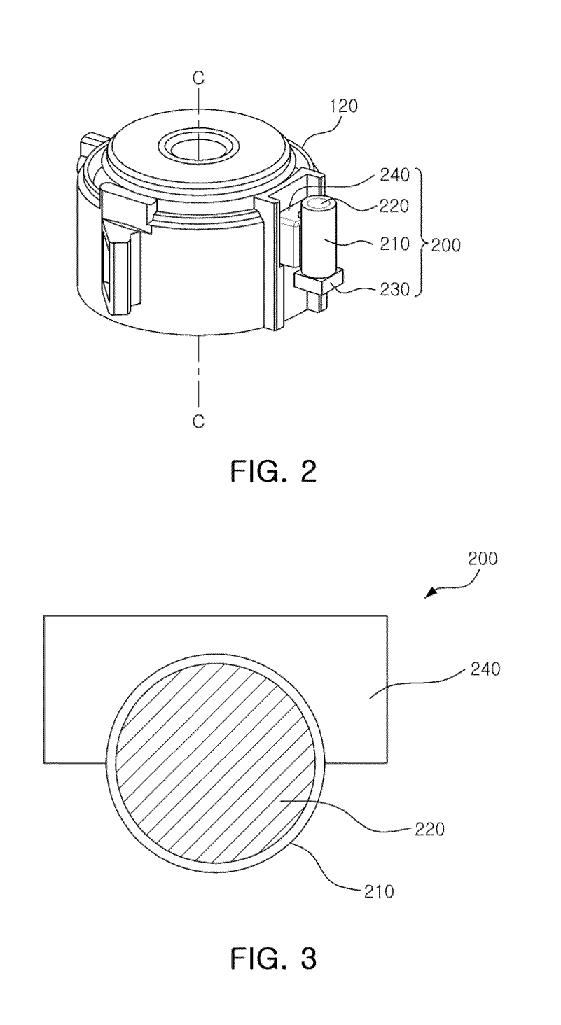

A coupling structure of the lens barrel 120 and the actuator 200 will be described with reference to FIG. 2.

The lens barrel 120 may be moved by the actuator 200 in an optical axis (C-C) direction. For example, the lens barrel 120 may be moved toward an object side (upwardly in FIG. 2) or an image side (downwardly in FIG. 2) by the actuator 200.

The actuator 200 may include the magnetic body 210, the piezoelectric member 220, the mass member 230, and the magnet member 240. The actuator 200 configured as described above may be closely adhered to one side of the lens barrel 120 to transfer driving force from the piezoelectric member 220 to the lens barrel 120.

The actuator 200 may be divided into two portions. For example, a first portion (the magnet member 240) of the actuator 200 may be mounted on the lens barrel 120, and a second portion (the magnetic body 210, the piezoelectric member 220, and the mass member 230) thereof may be mounted in the housing 110. Here, the first and second portions of the actuator 200 may be disposed so as to face each other to thereby drive the lens barrel 120 in the optical axis direction.

A transverse cross-sectional structure of the actuator 200 will be described with reference to FIG. 3.

In the actuator 200, the piezoelectric member 220 and the magnet member 240 may be configured so as to face each other. For example, the piezoelectric member 220 may be inserted into a groove of the magnet member 240 to thereby surface-contact the magnet member 240.

The magnetic body 210 is configured so as to increase coupling force between the piezoelectric member 220 and the magnet member 240. For example, the magnetic body 210 may be formed on a surface of the piezoelectric member 220 and be formed of a ferromagnetic material. For example, the magnetic body 210 may contain an iron powder, a nickel powder, and a cobalt powder.

The actuator 200 configured as described above may suppress the separation of the magnet member 240 and the piezoelectric member 220 through magnetic force formed between the magnetic body 210 and the magnet member 240.

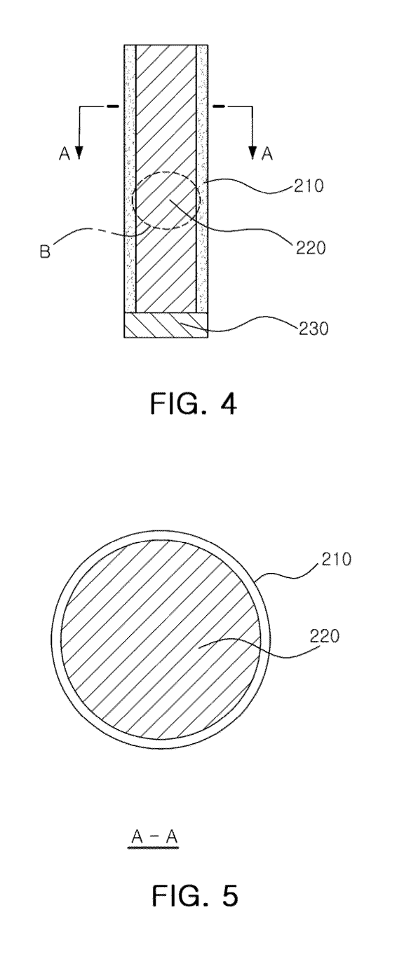

A longitudinal cross-sectional structure of the actuator 200 will be described with reference to FIG. 4.

The actuator 200 may be extended to be elongated in one direction. For example, the actuator 200 may be extended to be elongated in the optical axis direction. As an example, the piezoelectric member 220 may have a pillar shape in which it is extended to be elongated from one side of the mass member 230, and the magnetic body 210 may have a pipe shape in which it is extended so as to enclose an outer surface of the piezoelectric member 220.

The mass member 230 may be coupled to the magnetic body 210 and the piezoelectric member 220. The mass member 230 may have a predetermined mass. For example, the mass member 230 may have a mass larger than a sum of a mass of the magnetic body 210 and a mass of the piezoelectric member 220. The mass member 230 configured as described above may induce deformation energy (or driving force) in the piezoelectric member 220 to operate in the optical axis direction.

A cross-sectional structure of the actuator 200 will be described with reference to FIG. 5.

The actuator 200 may have a substantially circular cross section. For example, the piezoelectric member 220 may have a circular cross section, and the magnetic body 210 may have an annular cross section that is substantially equal or identical to the circular cross section of the piezoelectric member 220.

Since in the actuator 200 configured as described above, the piezoelectric member 220 and the magnetic body 210 are always closely adhered to each other, this structure may be advantageous for transferring driving force of the piezoelectric member 220 to the magnet member 240 or the lens barrel 120 through the magnetic body 210.

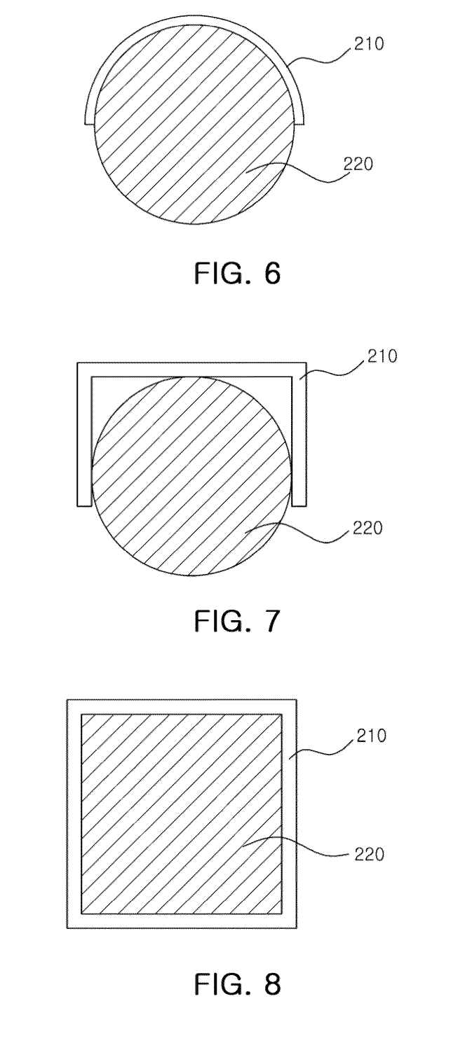

Another cross-sectional structure of the actuator 200 will be described with reference to FIG. 6.

The actuator 200 may have a substantially circular cross section. For example, the piezoelectric member 220 may have a circular cross section, and the magnetic body 210 may have an annular cross section enclosing only one portion of the piezoelectric member 220.

Since in the actuator 200 configured as described above, the magnetic body 210 is only formed one portion of the piezoelectric member 220, this structure may be advantageous for forming an external electrode on the piezoelectric member 220.

Another cross-sectional structure of the actuator 200 will be described with reference to FIG. 7.

A cross section of the actuator 200 may have a substantially mixed form in which a circular cross section and a tetragonal cross section are mixed. For example, the piezoelectric member 220 may have a circular cross section, and the magnetic body 210 may have a “E”-shaped cross section in which one surface thereof is open.

In the actuator 200 configured as described above, it maybe easy to couple the magnetic body 210 and the piezoelectric member 220 to each other.

Another cross-sectional structure of the actuator 200 will be described with reference to FIG. 8.

The actuator 200 may have a substantially tetragonal cross section. For example, the piezoelectric member 220 may have a tetragonal cross section, and of the magnetic body 210 may have a tetragonal cross sectional shape in which the piezoelectric member 220 is received therein.

In the actuator 200 configured as described above, it may be easy to manufacture the magnetic body 210 and the piezoelectric member 220.

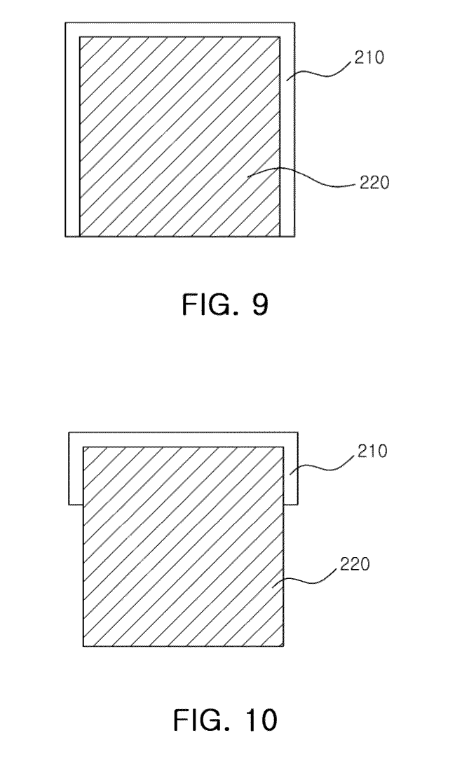

Another cross-sectional structure of the actuator 200 will be described with reference to FIGS. 9 and 10.

The actuator 200 may have a substantially tetragonal cross section. For example, the piezoelectric member 220 may have a tetragonal cross section, and the magnetic body 210 may have a “E”-shaped cross section partially enclosing an outer surface of the piezoelectric member 220.

Since in the actuator 200 configured as described above, the magnetic body 210 is only formed on one portion of the piezoelectric member 220, this structure may be advantageous for decreasing manufacturing costs and lightening the actuator 200.

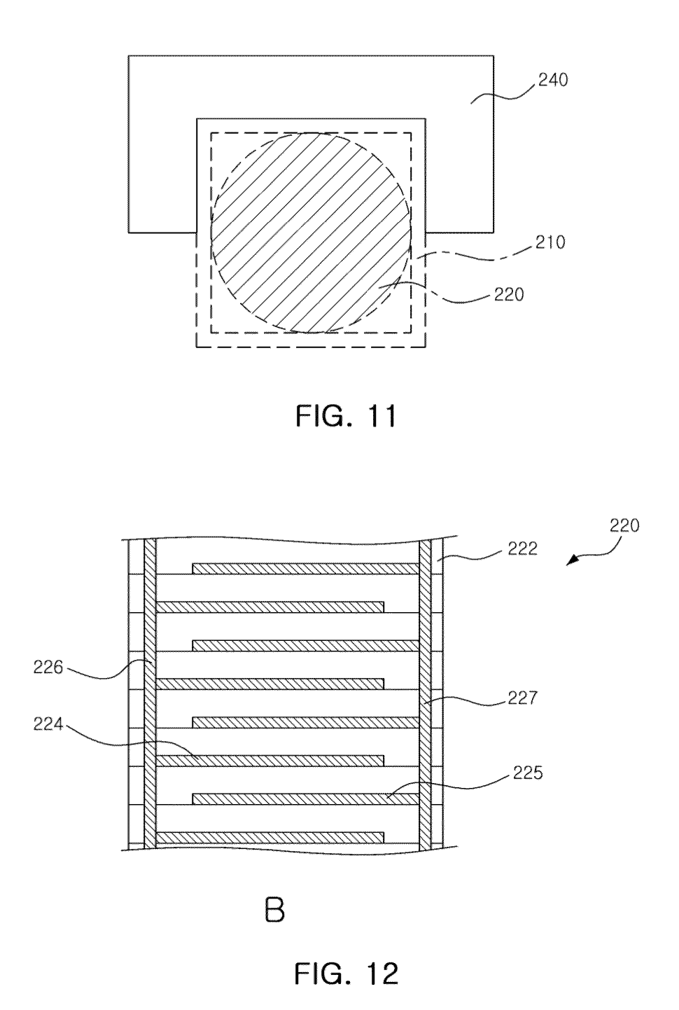

Another shape of the magnet member 240 will be described with reference to FIG. 11.

The magnet member 240 may have a groove having a substantially tetragonal cross section. The magnet member 240 formed as described above may be advantageous for being coupled to the magnetic body 210 and the piezoelectric member 220 of the actuator 200 illustrated in FIGS. 7 through 10.

An internal structure of the piezoelectric member 220 will be described with reference to FIG. 12.

The piezoelectric member 220 may include a plurality of ceramic layers 222 and a plurality of electrodes 224 to 227. For example, the piezoelectric member 220 may be formed as a stacked structure of the ceramic layers 222. Here, a stacking direction of the ceramic layer 222 may be the optical axis direction or a direction perpendicular thereto with respect to the optical axis. The electrode 224 or 225 may be formed on each of the ceramic layers 222. For example, the electrode 224 having a first polarity may be formed on an odd numbered ceramic layer 222, and the electrode 225 having a second polarity may be formed on an even numbered ceramic layer 222. These electrodes 224 and 225 are connected through via electrodes 226 and 227 penetrating through the ceramic layers 222, respectively.

In the piezoelectric member 220 configured as described above, a magnitude and a direction of driving force may be adjusted by adjusting an intensity of a current supplied to the electrodes 224 to 227.

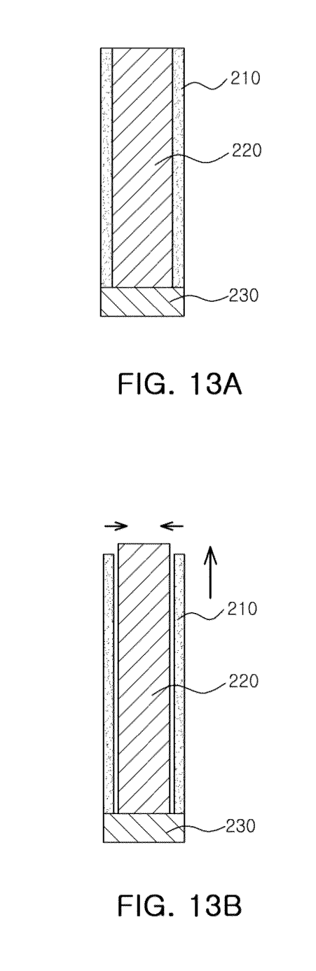

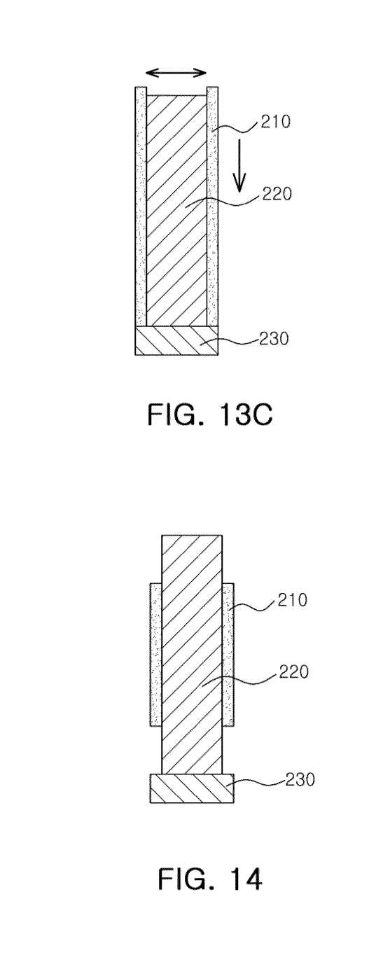

Deformation characteristics of the actuator 200 will be described with reference to FIGS. 13A through 13C.

The actuator 200 may have deformation characteristics substantially parallel to the optical axis direction. For example, the actuator 200 in a normal state is not deformed (FIG. 13A), but when a current is supplied to the piezoelectric member 220, the actuator 200 may be deformed in the optical axis direction (FIGS. 13B and 13C).

As an example, when a first signal is supplied to the piezoelectric member 220, a size of the cross section of the piezoelectric member 220 may be decreased, but a length of the piezoelectric member 220 may be increased (FIG. 13B). On the other hand, when a second signal is supplied to the piezoelectric member 220, the size of the cross section of the piezoelectric member 220 may be enlarged, but the length of the piezoelectric member 220 may be contracted (FIG. 13C).

Expansion and contraction movement of the piezoelectric member 220 as described above may induce a repetitive contact between the magnetic body 210 and the magnet member 240, such that the lens barrel 120 may be moved.

Another shape of the actuator 200 will be described with reference to FIG. 14.

The actuator 200 may be manufactured so that the magnetic body 210 and the piezoelectric member 220 have different heights. For example, the piezoelectric member 220 may be formed to be elongated from one surface of the mass member 230 in one direction, and the magnetic body 210 may be formed only in some section of the piezoelectric member 220. For example, a length of the section in which the magnetic body 210 is formed may be larger than a driving distance of the lens barrel 120.

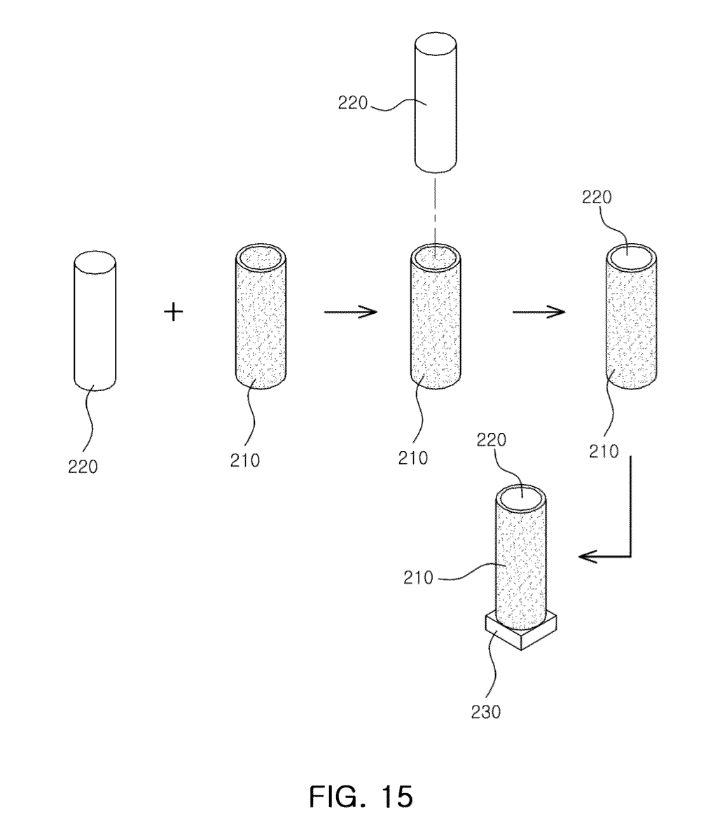

A manufacturing method of an actuator 200 according to an exemplary embodiment of the present disclosure will be described with reference to FIG. 15.

The manufacturing method of an actuator 200 may include a preparing step of preparing a magnetic body 210 and a piezoelectric member 220, a coupling step of coupling the magnetic body 210 to the piezoelectric member 220; and a coupling step of coupling the piezoelectric member 220 to a mass member 230.

1) Preparing Step of Preparing Magnetic Body 210 and Piezoelectric Member 220

In this step, the magnetic body 210 and the piezoelectric member 220 may be manufactured. For example, this step includes a process of manufacturing the magnetic body 210 in a pipe shape and a process of manufacturing the piezoelectric member 220 in a pillar shape. However, the shapes of the magnetic body 210 and the piezoelectric member 220 are not limited thereto. For example, the piezoelectric member 220 may be manufactured to have a prism shape.

2) Coupling Step of Coupling Magnetic Body 210 and Piezoelectric Member 220

This step includes a process of inserting the piezoelectric member 220 into the magnetic body 210. For example, in this step, the piezoelectric member 220 may be inserted into the magnetic body 210 by a press-fitting method.

3) Coupling Step of Coupling Piezoelectric Member 220 and Mass Member 230

This step may include a process of adhering the mass member 230 to one end of the piezoelectric member 220. For example, in this step, the mass member 230 may be adhered to one end of the piezoelectric member 220 by an adhesive.

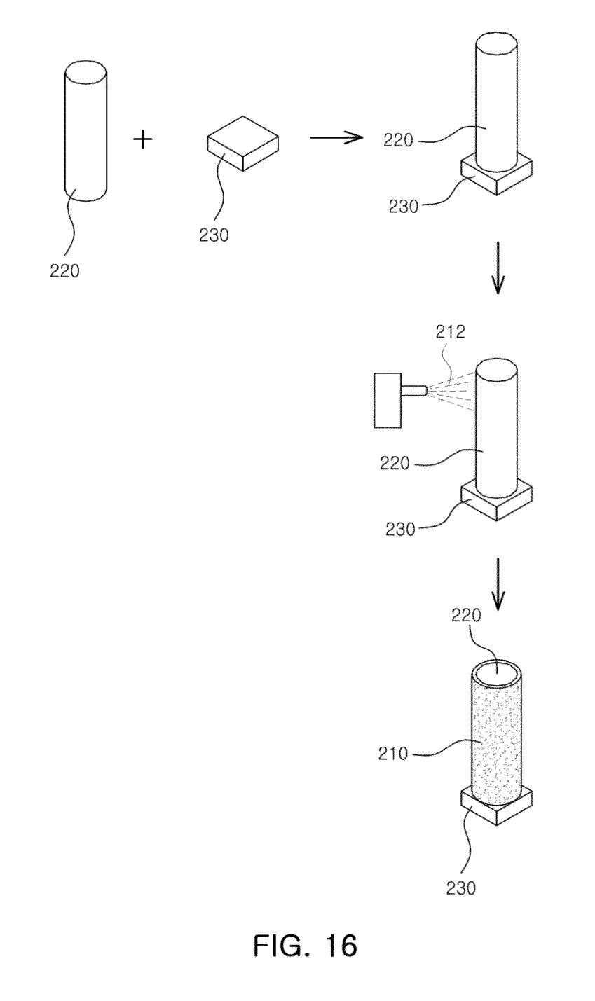

A manufacturing method of an actuator 200 according to another exemplary embodiment of the present disclosure will be described with reference to FIG. 16.

The manufacturing method of an actuator 200 may include a coupling step of a piezoelectric member 220 and a mass member 230 and a forming step of magnetic body 210. For example, the magnetic body 210 may be formed on the piezoelectric member 220 by a method of spraying, depositing, or printing a magnetic powder 212 thereon, or the like.

As set forth above, according to exemplary embodiments of the present disclosure, driving reliability of the piezoelectric member may be improved by decreasing contact wear due to the contact between the lens barrel and the piezoelectric member.

While exemplary embodiments have been shown and described above, it will be apparent to those skilled in the art that modifications and variations could be made without departing from the spirit and scope of the present disclosure as defined by the appended claims.

What is claimed is:

1. An actuator comprising:
a piezoelectric member extended to be elongated in an optical axis direction; and
a magnetic body disposed on the piezoelectric member so as to decrease contact wear between the piezoelectric member and a lens barrel.

2. The actuator of claim 1, wherein the magnetic body is disposed on a surface of the piezoelectric member.

3. The actuator of claim 1, wherein the magnetic body is disposed on one surface of the piezoelectric member facing the lens barrel.

4. The actuator of claim 3, wherein the magnetic body includes a powder so as to be easily formed by paste printing or dipping.

5. The actuator of claim 1, further comprising a magnet member disposed on the lens barrel and generating magnetic force in the magnetic body.

6. The actuator of claim 1, further comprising a mass member disposed on one end of the piezoelectric member.

7. A camera module comprising an actuator for auto-focusing, wherein the actuator includes:
a piezoelectric member providing driving force required to move a lens barrel in an optical axis direction;
a magnet member disposed on the lens barrel; and
a magnetic body disposed on the piezoelectric member so that driving force of the piezoelectric member is transferred to the lens barrel.

8. The camera module of claim 7, wherein the piezoelectric member has a cylindrical shape or a prism shape extended in the optical axis direction, and
the magnetic body is configured to have a cylindrical shape or a prism shape so that the piezoelectric member is received therein.

9. The camera module of claim 7, wherein the magnetic body includes a powder so as to be easily formed by paste printing or dipping.

10. The camera module of claim 7, wherein the actuator includes a mass member disposed on the piezoelectric member.
